(19) United States
(12) Patent Application Publication
(10) Pub. No.: US 2003/0168421 A1
(43) Pub. Date: Sep. 11, 2003

(54) Telehandler crane apparatus

(76) Inventor: Daniel E. Davis, Harlingen, TX (US)

Correspondence Address: ALTON W. PAYNE, SUITE 200, 5001 BISSONNET, BELLAIRE, TX, 77401, US

(21) Appl. No.: 10/094,341

(22) Filed: Mar. 8, 2002

(51) Int. Cl. B66C 23/78

(52) U.S. Cl. 212/302

(57) ABSTRACT

A telehandler crane apparatus and method is provided. More particularly, the present invention relates to a mobile apparatus adaptable for use as a crane and as a telehandler, and an associated method. The telehandler crane includes a telehandler frame, an outrigger assembly engaged with the telehandler frame, a rotating assembly engaged with the telehandler frame adapted for rotating 360 degrees, and a boom engaged with the rotating assembly such that the boom can be rotated 360 by the rotating assembly. Further, the telehandler crane apparatus of the present invention can be operated remote from the telehandler crane apparatus by the operator using a remote docking base.

### FIELD OF THE INVENTION

The present invention relates generally to mobile all terrain apparatuses. The present invention relates to mobile telescopic handlers and crane apparatus. More particularly, the present invention relates to a mobile apparatus adaptable for use as a crane and as an telescopic handler, and associated methods.

### BACKGROUND OF THE INVENTION

Heavy duty earth moving and material handling equipment is very expensive. Each piece of equipment can represent a significant investment to accomplish a very specific or limited utility with respect to the piece of equipment. The industry has recognized the need to have such expensive equipment serve more general or at lease multiple applications. An example is the familiar back-hoe device having loader arms on one end mounted with a digging bucket or scraper, and a swiveling articulated boom at the other end mounted with a bucket, jack hammer or another material handling device. For example, the industry has taken the familiar back-hoe device and adapted it to new applications to increase their utility. U.S. Pat. No. 4,175,902 to Heroz, et al. is an example of such a novel adaptation of a familiar tool to achieve new utility. Other novel adaptations which increase the scope of application of existing equipment are beneficial to the industry. A device is needed for mounting different booms, e.g., a crane boom or an excavator boom, to the same platform.

Also, material handling equipment is very expensive. Each piece of equipment can represent a significant investment to accomplish a very specific or limited utility with respect to the piece of equipment. The industry has recognized the need to have smaller machines that can handle a variety of small jobs quickly in any environment. The industry has noted that any time saved in the movement of materials equates to greater profits from the saved time. Also, the Industry has recognized the need to have equipment that can transport its self on public roads. An example is the familiar back-hoe machines normally provide the ability to do several jobs on a work site quickly and have wheels to transport themselves around a job site or on public roads. The industry has taken familiar crane equipment and placed them upon wheels. Grove, an equipment company, has a wheeled industrial crane. Also, Another equipment company, Broverson, manufactures a wheeled crane. Novel adaptations which increase the scope of application of existing equipment are beneficial to the industry. A device is needed that is a quick and easy to transport crane device with a wide range of rotation and great load handing ability.

There exists a need for a man-bucketed telehandler. Also, there exists a need for a telehandler crane apparatus that can pick up a full load at close proximity to the load. Further, there exists a need for a telehandler crane apparatus that can be remotely controlled. And there exists a need for a telehandler crane apparatus that can interchange crane with forks, and the boom of the crane can rotate 360 degrees.

It is, therefore, a feature of the present invention to provide an telehandler crane apparatus that has a telescoping arm or boom that can be rotated up to and exceeding 360 degrees.

A feature of the present invention is to provide an telehandler crane apparatus with an outrigger assembly using heavy-duty materials. The use of heavy-duty parts allows the all-terrain telehandler crane to be more stable so as to have a greater peak load. Therefore, the telehandler crane apparatus can engage and lift a heavier load before reaching its tipping moment.

Another feature of the present invention is to provide a telehandler crane apparatus that has a double counterweight system.

Yet still another feature of the present invention is to provide a telehandler crane apparatus with a reinforced box frame formed by a “U” member and reinforcement plates.

Yet further, an additional feature of the present invention is to provide a telehandler crane apparatus with a telescoping arm retractable for easy transport and movement.

Yet still further, an additional feature of the present invention is to provide a telehandler crane apparatus with the ability to remotely control crane functions.

Yet still further, an additional feature of the present invention is to provide a telehandler crane apparatus that will lift a full more weight than normal telehandlers.

Yet still further, an additional feature of the present invention is to provide a telehandler crane apparatus with the pivot point of the telehandler boom behind the rear outrigger.

Still further, an additional feature of the present invention is to provide a method for lifting a full capacity while being in close proximity to the load.

Still further, an additional feature of the present invention is to provide a method for remotely controlling the crane functions from outside the operator compartment.

Still further, an additional feature of the present invention is to provide a method for attaching a man basket to the end of the telehandler arm.

Still further, an additional feature of the present invention is to provide a method for remotely controlling the functions of the telehandler arm while being operated from a man basket.

It is, therefore, a further feature of the present invention to provide a conversion apparatus and method for use with telescopic handlers and crane devices for mounting different booms to the same platform.

A feature of the present invention is to provide a conversion apparatus and method for use with telescopic handlers and crane devices for converting the telescopic handler to be a crane.

Another feature of the present invention is to provide a conversion apparatus and method for use with telescopic handler and crane devices that can accept either telehandler implements or crane implements.

Yet another feature of the invention is to provide a conversion apparatus and method for use with telescopic handler and crane devices that is stable when adapted to be used as a crane or as a telehandler.

Still another feature of the present invention is providing a conversion apparatus and method for use with telescopic handler and crane devices that provides a range of boom angles comparable to the range of boom angles available to the boom connected to the telescopic handler body.

Yet still another feature of the present invention is to provide a conversion apparatus and method for use with telescopic handler and crane devices having the same operating and stability characteristics as a crane.

Yet further, an additional feature of the present invention is to provide a method for adapting a telescopic handler for use as a crane.

Yet still further, an additional feature of the present invention is to provide a method for adapting various boom devices for use with nonconforming superstructure and telescopic handler components.

Yet still further, an additional feature of the present invention is to provide an article of manufacture for adapting an telescopic handler for use as a crane.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

To achieve the foregoing objects, features, and advantages and in accordance with the purpose of the invention as embodied and broadly described herein, an telehandler crane apparatus is provided. The telehandler crane includes a telehandler frame, an outrigger assembly engaged with the telehandler frame, a rotating assembly engaged with the telehandler frame adapted for rotating 360 degrees, and a boom engaged with the rotating assembly such that the boom can be rotated 360 by the rotating assembly. Further, the telehandler crane apparatus of the present invention can be operated remote from the telehandler crane apparatus by the operator using a remote docking base.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a side view of a preferred embodiment of a telehandler crane apparatus as practiced by the present invention.

FIG. 1A is a side view of a preferred embodiment of a telehandler crane apparatus as practiced by the present invention.

FIG. 2 is a front view of a preferred embodiment of a telehandler crane apparatus as practiced by the present invention.

FIG. 3 is a side view of a preferred embodiment of a telehandler crane apparatus as practiced by the present invention.

FIG. 4 is a front view of a preferred embodiment of a telehandler crane apparatus as practiced by the present invention.

FIG. 5 is a rear view of a preferred embodiment of a telehandler crane apparatus as practiced by the present invention.

FIG. 5A is a rear view of a preferred embodiment of a telehandler crane apparatus as practiced by the present invention.

FIG. 6 is a side view of a preferred embodiment of a telehandler crane apparatus as practiced by the present invention with the boom extended in a forward direction.

FIG. 7 is a side view of a preferred embodiment of a partial telehandler crane apparatus as practiced by the present invention without the operator compartment, wheels and drive train.

FIG. 8 is a side view of a preferred embodiment of a telehandler crane apparatus as practiced by the present invention with the boom extended in a rear direction, and illustrating the boom in an upper and lower position.

FIG. 9 is a perspective view of the operator compartment of the telehandler crane apparatus as practiced by the present invention.

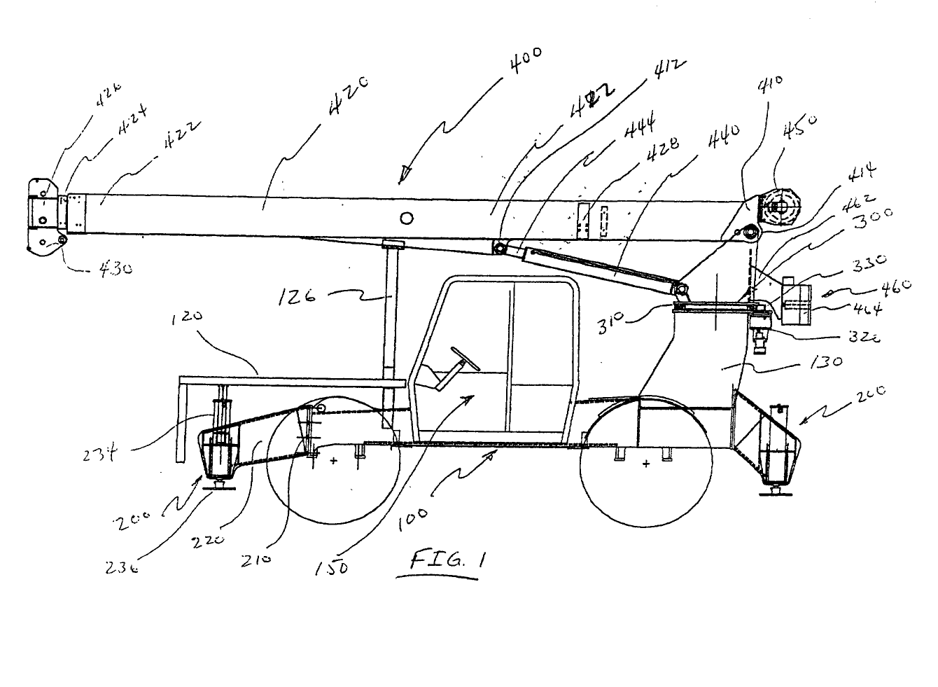

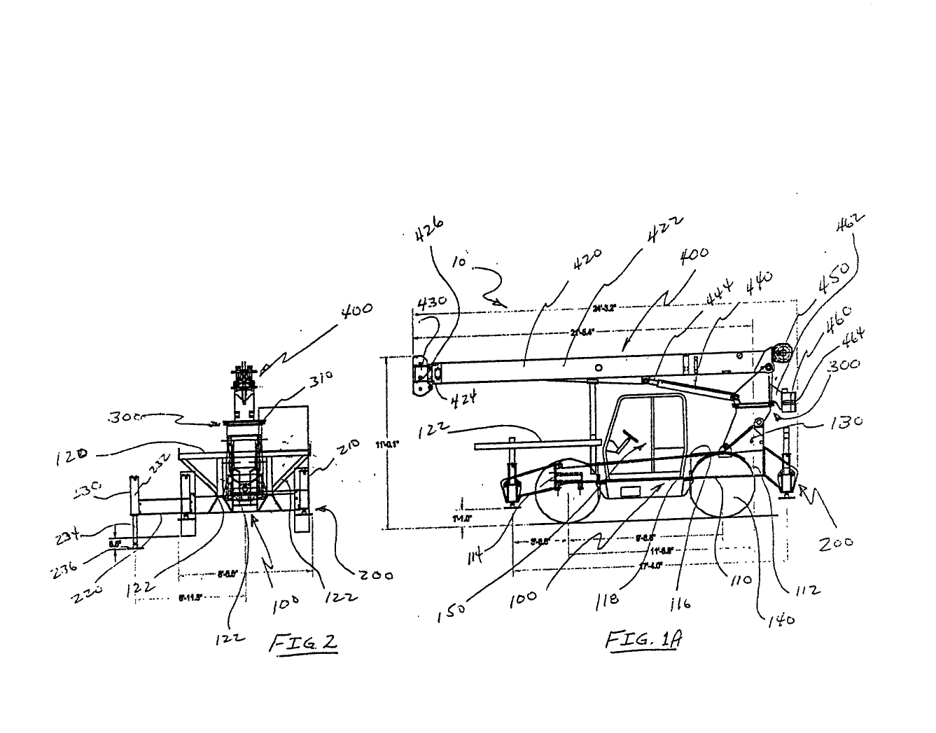

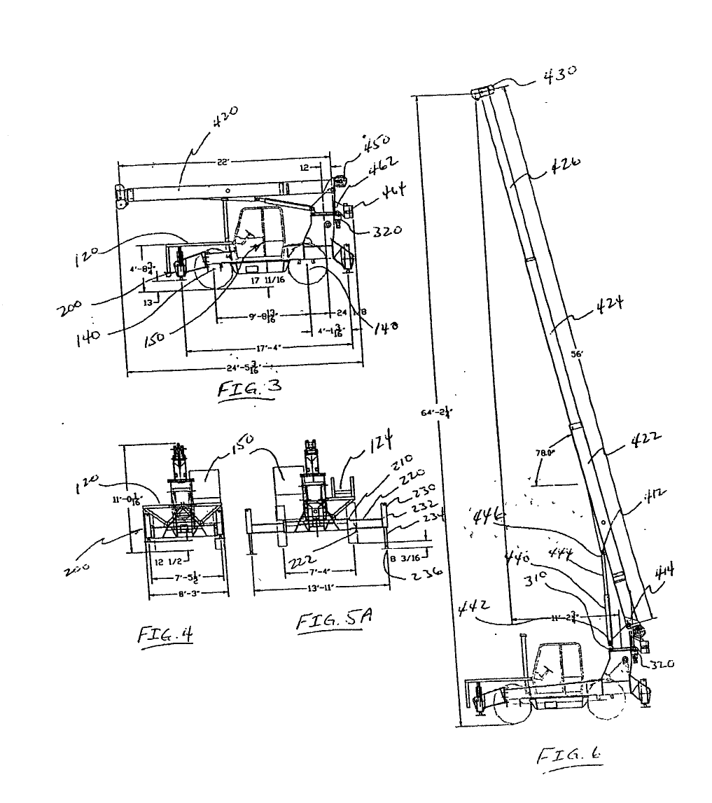

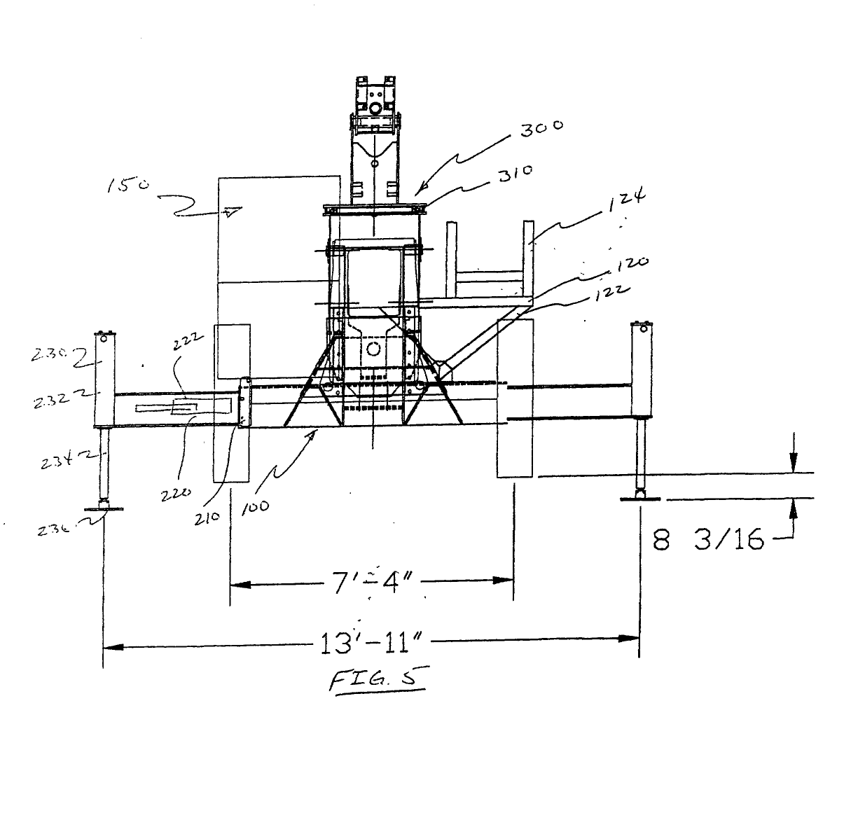

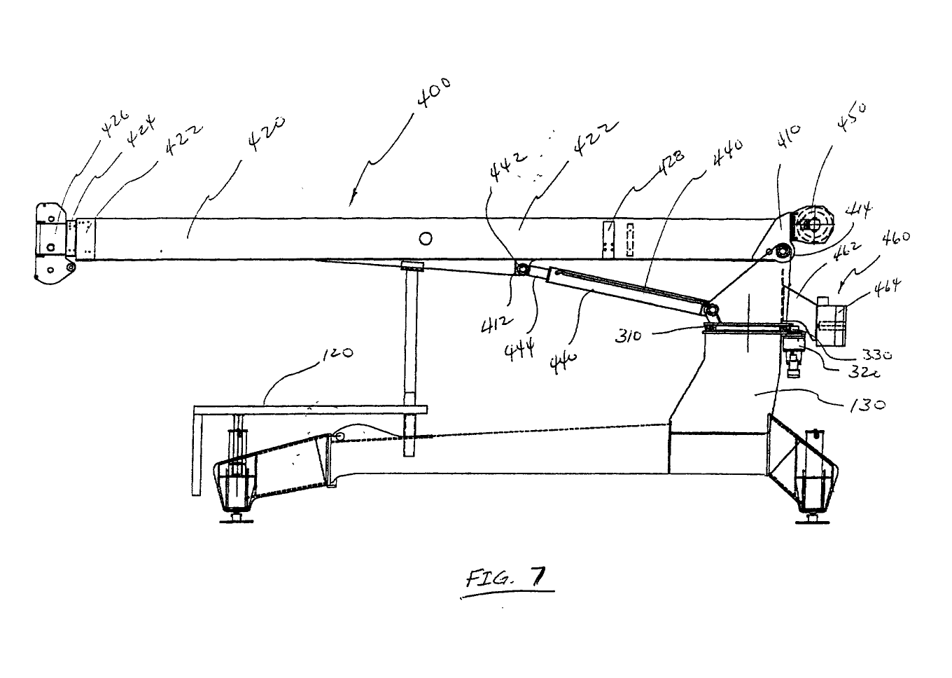

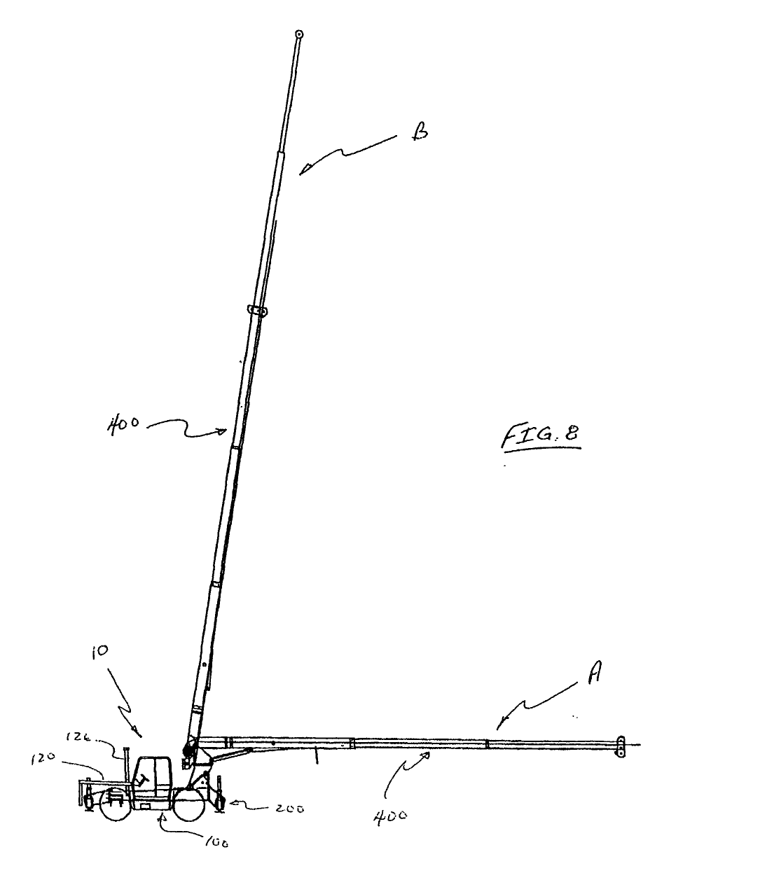

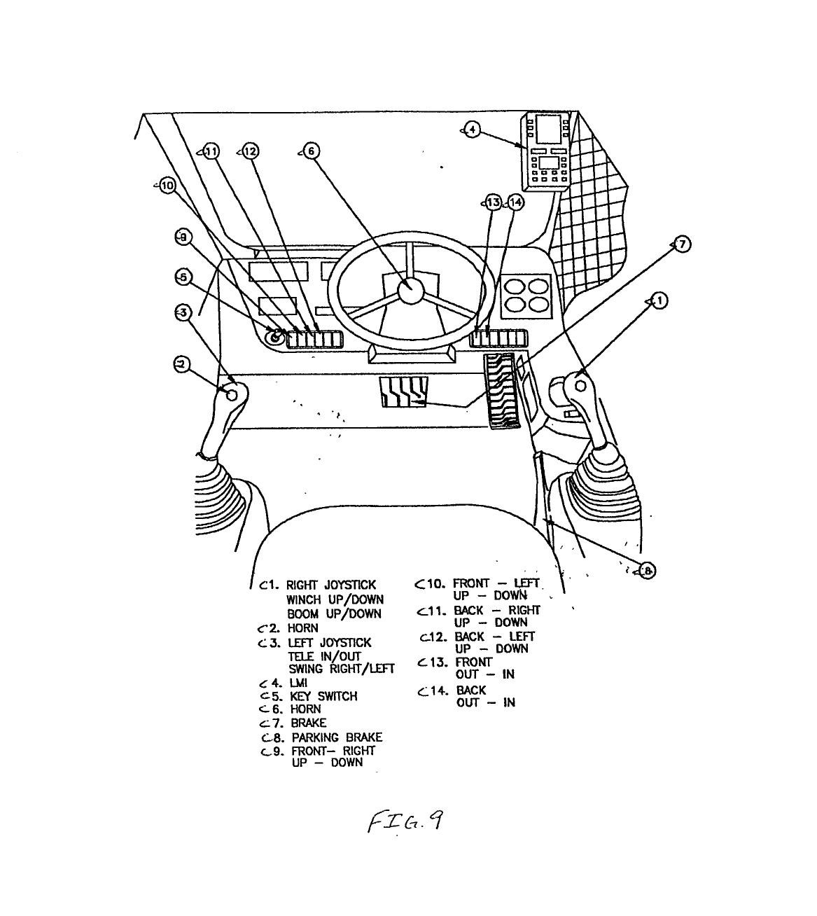

Table 1 lists specifications for the telehandler crane apparatus of present invention.

Chart 1 is a load rating chart for the telehandler crane apparatus of present invention.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

One preferred embodiment describes an telehandler crane apparatus 10 comprised of a frame 100, an outrigger assembly 200, a rotating assembly 300, and a boom assembly 400.

The frame 100 is comprised of a box 110 further comprised of a “U” shaped member 112 with a welded front plate 114. The welded front plate 114 is attached to the “U” shaped member 112 to create an enclosed area. The box 110 is further comprised of top plates 116 and bottom plates 118 that are attached to the bottom side and top side of the box 110. The frame 100 has a carry deck 120 attached to the box 110 at the front end of the “U” shaped member 112 using support members 122. The carry deck is attached to the box 110 using support members 122. The support members 122 position the carry deck 120 parallel to the box 110. The support members 122 form a “honey comb” support structure between the carry deck 120 and the frame 100.

The frame 100 has a weldment 130 attached to the “U” shaped member 112 at its apex. The weldment 130 is positioned perpendicular to the box 110.

The frame 100 is further comprised of drive train 140 and an operator compartment 150. The drive train is comprised of the wheels, transmission, engine, axles, and other required linkage to enable the telehandler crane apparatus 10 to move and operate the hydraulics. The telehandler crane apparatus 10 has an all wheel drive system to move the crane. Also, the crane is steered using front wheels that turn.

The operator compartment 150 is comprised of a seat for the operator, controls for movement of the chasis, controls for movement of the boom and winch, and electronics. The operator compartment 150 can be open or enclosed against weather and can be constructed of round tubing.

The operator compartment 150 is located on the left side of the box 110 when standing behind the telehandler crane apparatus 10. The telehandler crane apparatus 10 has three pipe racks located to the right of the operator compartment. The pipe rack is used to transport pipe to job locations.

The outrigger assembly 200 is comprised of a rigid attachment 210, a telescoping arm 220, and a outrigger member 230. The telescoping arm contains a hydraulic cylinder 222 that telescopes relative to the rigid attachment 210. The outrigger assemblies 200 hydraulically telescope away from the corners of the telehandler crane apparatus 10 perpendicular to the tires and parallel to the front and back of the crane 10. The outrigger assembly 200 has rigid attachments 210 in the front and rear of the crane telehandler crane apparatus 10. The rigid attachments 210 on the front of the crane 10 are longer than the shorter rigid attachments 210 in the rear.

The outrigger member 230 is comprised of a cylinder 232, a piston 234, and a foot 236. The piston 234 is housed within the cylinder 232 and is moved closer to the stationary surface by hydraulics. The cylinder has a foot 236 that is attached at one end of the cylinder. The foot 236 is the part of the cylinder that comes into contact with the resting surface when the cylinder is actuated closer the stationary surface.

The rotating assembly 300 is comprised of a bearing 310, a hydraulic motor 320, and a pinion 330. The bearing 310 is attached to the weldment 130 and is rotated about the weldment 130 using the pinion 330. The hydraulic motor 320 provides the force to turn the bearing 310.

The boom assembly 400 is comprised of a base 410, a telescoping arm 420, a block assembly 430, a pivoting hydraulic cylinder 440, a winch 450, and a double counterweight system 460. The base 410 is attached to the bearing 310 and can be rotated up to 372 degrees. The base 410 further contains a 1st pivoting member 412 and a 2nd pivoting member 414. The telescoping arm 420 is attached to the 1st pivoting member 412 and the 2nd pivoting member 414. A boom rest pedestal 126 is attached to the carry deck 120 and creates a surface parallel to the carry deck 120 for the telescoping arm 420 to be placed upon during movement or storage.

The telescoping arm 420 is comprised of a 1^{st} arm 422, a 2^{nd} arm 424, a 3rd arm 426, and a telescoping hydraulic cylinder 428. The 1^{st} arm 422 contains the telescoping hydraulic cylinder 428. The telescoping hydraulic cylinder 420 extends the 2^{nd} arm 424 that is positioned within the 1^{st} arm 422. The 3^{rd} arm 426 is positioned within the 2^{nd} arm 424. The 1^{st} arm 422, the 2^{nd} arm 424, and the 3^{rd} arm 426 are constructed of square tubing. The telescoping hydraulic cylinder 420 has a piston that as it is extended under hydraulic pressure extends to lengthen to overall length of the arm. The 2^{nd} arm 424 extends out of the 1^{st} arm 422 first. Then, the 3^{rd} arm 426 extends out of the 2^{nd} arm. The block assembly 430 is attached to the third arm 426 at the end opposite the base 410.

The telescoping arm 420 is attached to the base 410. The attachment of the telescoping arm 420 to the base 410 further comprises the 1^{st} arm 424 attached to the 1^{st} pivoting member 412 and the 2^{nd} pivoting member 414. The 1^{st} arm 424 and the 1^{st} pivoting member 412 are connected by the pivoting hydraulic member 440. The pivoting hydraulic cylinder 440 is comprised a 1^{st} attachment member 442, a piston 444, and a 2^{nd} attachment member 446. The 1^{st} attachment member is on the side of the piston closest to the base 410. The 2^{nd} attachment member is on the opposite side of the piston as the 1^{st} attachment member and is closest to the 1^{st} arm 424. The 1^{st} attachment member 442 is attached to the 1^{st} pivoting member 412. The 2^{nd} attachment member 446 attaches to the 1^{st} arm 424.

The winch 450 is attached to the 1^{st} arm 424. The winch is located on the end of the 1^{st} arm 424 closest to the base 410. The winch 450 is comprised of a spool, a hydraulic motor, and cable. The winch 450 controls the cable and the movement of cable through pulley found on the end of the 3^{rd} arm 426 and through the block assembly 430.

The double counter weight system 460 is comprised of arms 462 and counterweights 464. The arms 462 of the double counter weight system 460 are attached to the base 410. The arms 462 may be able to extend. The counterweights 464 are attached to the arms 462. The counter weights 464 can be of different masses on each of the two arms 462. The arms 462 are attached so that the winch 450 will fit between the counterweights 464 when the telescoping arm 420 is pivoted to a large angle relative to the frame 100.

The telehandler crane apparatus 10 has a Load moment indicator (LMI). The LMI is used to keep the telehandler crane apparatus 10 from tipping over. The LMI determines both the radius of the telescoping arm 420 and the loaded boom angle of the telescoping arm 420. Next, the LMI determines the maximum load at that radius and angle. The LMI has lock out control of the telescoping hydraulic cylinder. The LMI activates the lock out control when the maximum load capacity has been met for a given radius and angle.

The telehandler crane apparatus 10 has an Anti-two block system. The Anti-two block system insures that the block assembly 430 and the hook on the end of the cable does not touch and place force upon the block assembly 430. The Anti-two block system locks out hydraulic power to the winch 150 when the hook and block assembly are in close orientation to keep damage to either of the two components from occurring.

Additional advantages and modification will readily occur to those skilled in the art. The invention in its broader aspects is therefore not limited to the specific details, representative apparatus, and the illustrative examples shown and described herein. Accordingly, departures may be made from the details without departing from the spirit or scope of the disclosed general inventive concept.

What is claimed is:

1. A telehandler crane apparatus for freely suspending a load above the ground comprising:
a rotating assembly, and a boom assembly
(a) a telehandler frame,
(b) an outrigger assembly engaged with the telehandler frame,
(c) a rotating assembly engaged with the telehandler frame adapted for rotating 360 degrees, and
(d) a boom engaged with the rotating assembly such that the boom can be rotated 360 by the rotating assembly.
